(19) United States
(12) Patent Application Publication
(10) Pub. No.: US 2006/0086898 A1
(43) Pub. Date: Apr. 27, 2006

(54) Method and apparatus of making highly repetitive micro-pattern using laser writer

(75) Inventors: Chen-Hsiung Cheng, Westford, MA (US); Ira Nydick, Osaka (JP); Yosuke Mizuyama, Cambridge, MA (US)

Correspondence Address: HARNESS, DICKEY & PIERCE, P.L.C., P.O. BOX 828, BLOOMFIELD HILLS, MI, 48303, US

(73) Assignee: Matsushita Electric Industrial Co., Ltd., Osaka (JP)

(21) Appl. No.: 10/973,990

(22) Filed: Oct. 26, 2004

(51) Int. Cl. H01J 3/14

(52) U.S. Cl. 250/236

(57) ABSTRACT

An apparatus for making a highly repetitive micro-pattern using a laser writer includes one or more diffractive optical elements. At least one diffractive optical element is adapted to split a beam of a laser writer into sub-beams based on a separation distance matching a period of a repetitive structure to be formed in a laser-writable substrate. One or more f-theta lenses are also included. At least one f-theta lens is disposed to intercept the sub-beams, forming a periodic distribution of laser writer output beams.

### FIELD OF THE INVENTION

The present invention generally relates to a method of and apparatus for micro-patterning a laser writable substrate using a laser writer, and particularly relates to design and use of one or more diffractive optical elements to accomplish parallel processing in a laser writer.

### BACKGROUND OF THE INVENTION

Today's diffraction gratings, diffractive optical elements (DOEs) and/or amplitude masks for micro-devices can be obtained by using a laser writer to process a laser-writable substrate one pixel at a time. Accordingly, a single laser beam is being used to write a pattern on a whole wafer one repetitive pattern at a time. This process is very slow, and the need remains for a way to improve the processing speed.

Since grating (or DOE) performance (efficiency) depends on the beam coverage over multiple periodic structures, any variation from period to period degrades the performance. As a result, current laser writing processes are susceptible to long-term drift of parameters such as laser beam intensity, beam pointing, scanner response, scanning non-linearity and thermal expansion. Accordingly, the need remains for a way to decrease variation from period to period.

When multiple gratings (or DOES) are fabricated, variation from device to device degrades the yield and tolerance. As a result, current laser writing processes are susceptible to long-term drift of parameters such as laser beam intensity, beam pointing, scanner response, scanning non-linearity and thermal expansion. Accordingly, the need remains for a way to decrease variation from device to device.

It is further desirable to avoid variation from piece to piece that results from long-term drift of parameters of a laser writing process that occurs during mass production of (micro) optics. In order to make a large amount of identical optics, a mask aligner or a stepper is usually used in a step-and-repeat process. However, this process requires expensive equipment, leading to cost increase of the end product optics. In the case where the optics are no longer binary structures, e.g., binary gratings, a special grayscale photo mask must be installed in a mask aligner or a stepper, which is also expensive to obtain. On the other hand, there is a direct write method for making a grayscale structure by using a laser writer or an electron beam writer. However, in this method, individual elements are fabricated literally one by one, which greatly increases fabrication cost of the element even during mass production of the element. Thus there is a need for cheaper way to make a large amount of identical (micro and non-binary) optics.

The present invention fulfills the aforementioned needs.

### SUMMARY OF THE INVENTION

In accordance with the present invention, an apparatus for making a highly repetitive micro-pattern using a laser writer includes one or more diffractive optical elements. At least one diffractive optical element is adapted to split a beam of a laser writer into sub-beams based on a separation distance matching a period of a repetitive structure to be formed in a laser-writable substrate. One or more f-theta lenses are also included. At least one f-theta lens is disposed to intercept the sub-beams, forming a periodic distribution of laser writer output beams.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of a laser writer in accordance with the prior art;

FIG. 2 is a block diagram of a first embodiment of an apparatus for making a highly repetitive micro-pattern according to the present invention;

FIG. 3 is a block diagram of a second embodiment of an apparatus for making a highly repetitive micro-pattern according to the present invention;

FIG. 4 is a block diagram of an optical pickup system having an optical element produced according to the present invention integrated therein;

FIG. 5 is a block diagram of an integrated grating unit produced according to the present invention;

FIG. 6 is a flow diagram illustrating a method of making a highly repetitive micro-pattern according to the present invention;

FIGS. 7-10 are block diagrams illustrating simultaneous fabrication of identical grey scale optical elements and integration thereof in an optical pickup for use in optical disk apparatus.

### DETAILED DESCRIPTION OF THE PREFERRED EMBODIMENTS

The following description of the preferred embodiments is merely exemplary in nature and is in no way intended to limit the invention, its application, or uses.

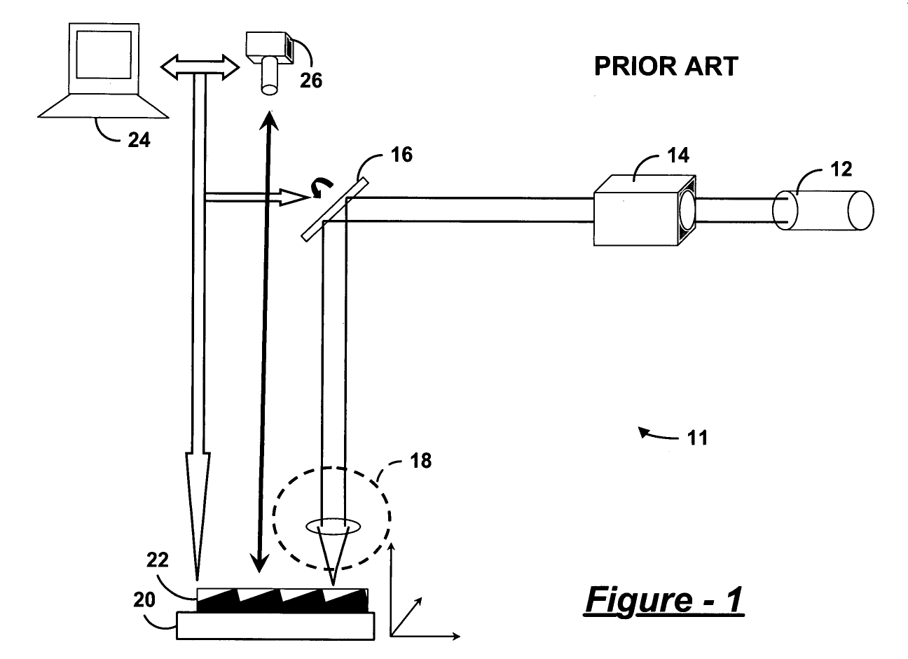

Referring to FIG. 1, a typical laser writer 11 includes a laser source 12 emitting a laser beam through a beam modulator/attenuator module 14 to a scanner mirror 16. Scanner mirror 16 redirects the laser beam through focal lens 18, which in turn, and together with X-Y-Z motion stage 20, determines spot size of the laser beam on laser writable substrate 22. Together, orientation of scanner mirror 16 and movement of X-Y-Z motion stage 20 determine position of the laser beam on a surface of the laser writable substrate 22. Computer processor 24, in response to feedback from focus tracking camera/laser 26, controls scanner mirror 16 and X-Y-Z motion stage 20 to trace a predetermined micro-pattern on the laser writable substrate 22 while keeping substrate 22 in focus. The exposed substrate 22 can then be developed and/or etched to obtain a predetermined structure in the substrate according to the micro-pattern.

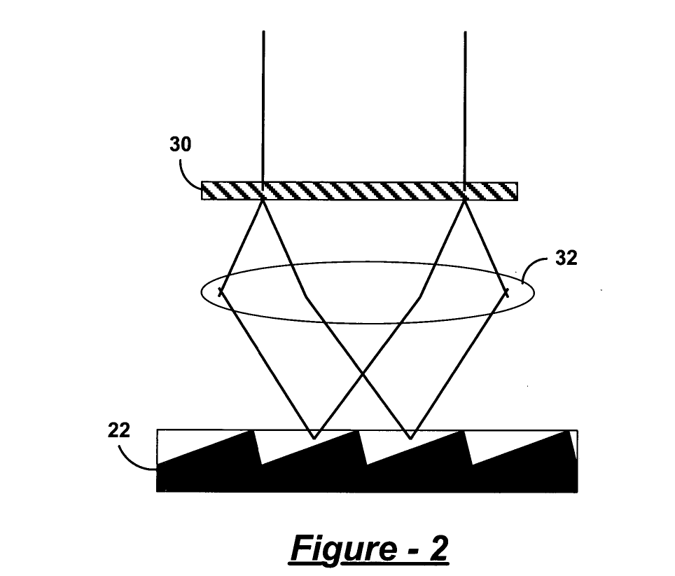

In accordance with the present invention, the laser source 12 is replaced with a high power and/or ultra-fast laser source. Also in accordance with the present invention, focal lens 18 is replaced with an apparatus according to a first embodiment of the present invention that includes at least one DOE and having an f-theta lens as illustrated in FIG. 2. The DOE 30 is adapted to split a beam of a laser writer into sub-beams based on a separation distance matching a period of a repetitive structure to be formed in a laser-writable substrate 22. F-theta lens 32 is disposed to intercept the sub-beams and form a periodic distribution of laser writer output beams. Thus, a micro-pattern for a single structure can result in simultaneous exposure of the substrate to multiple repetitions of the micro-pattern in a highly precise manner. While two sub-beams are illustrated, it is possible to form approximately four-hundred sub-beams from a single DOE. Thus, an optical element or other micro-element having highly repetitive structure can be formed quickly and with great precision.

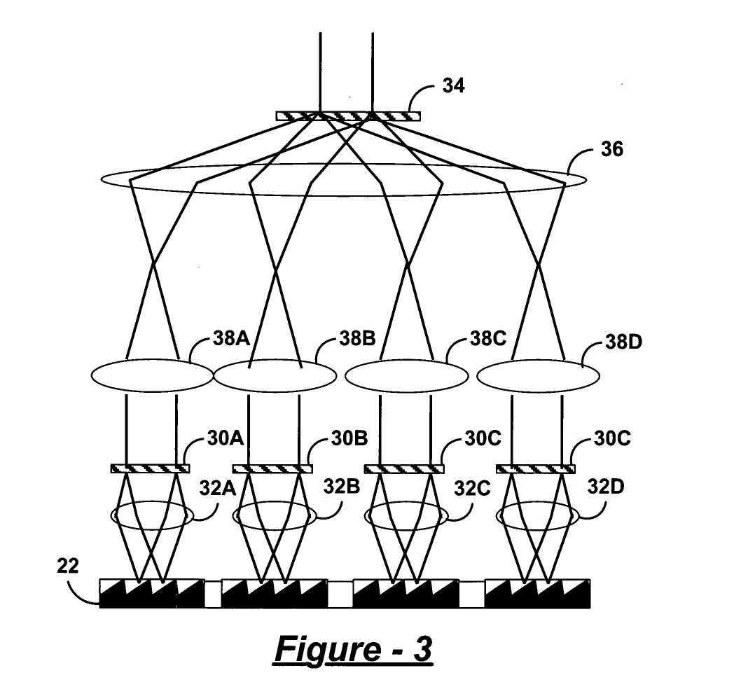

Turning now to FIG. 3, in a second embodiment, a first DOE 34 can be designed to split the beam to slightly larger than the spacing of each element to allow for dicing/separation. This hierarchical approach allows for parallel processing of multiple elements on a single wafer/substrate 22. For this application, the beam pattern is matched to a desired arrangement, but the arrangement of elements need not be regular. Similarly, if one DOE is not sufficient to provide coverage of the whole useable wafer area, one can first split the main laser beam into multiple separate beams as needed, and direct each beam to a separate, identical DOE for further beam splitting so as increase the covered area.

In some embodiments, the first DOE 34 produces multiple sub-beams that are intercepted by an additional f-theta scan lens 36. Then, multiple collimating lenses 38A-38D reform the sub-beams for use with multiple instances of the first embodiment. Accordingly, second DOEs 30A-30D operate to split the sub-beams according to the period of the structures to be formed in the elements, and f-theta lenses 32A-32D form the split sub-beams into multiple, spaced, periodic distributions of laser writer output beams. However, it is envisioned that other arrangements of optical elements can be employed to split the main beam into sub-beams suitable for use with multiple instances of the first embodiment. Moreover, it is envisioned that the first embodiment and the second embodiment can include a scan lens, image transfer lenses, and a microfilter as disclosed in System and Method of Laser Drilling, to Liu et al., U.S. Pat. No. 6,720,519, incorporated herein by reference in its entirety for any purpose.

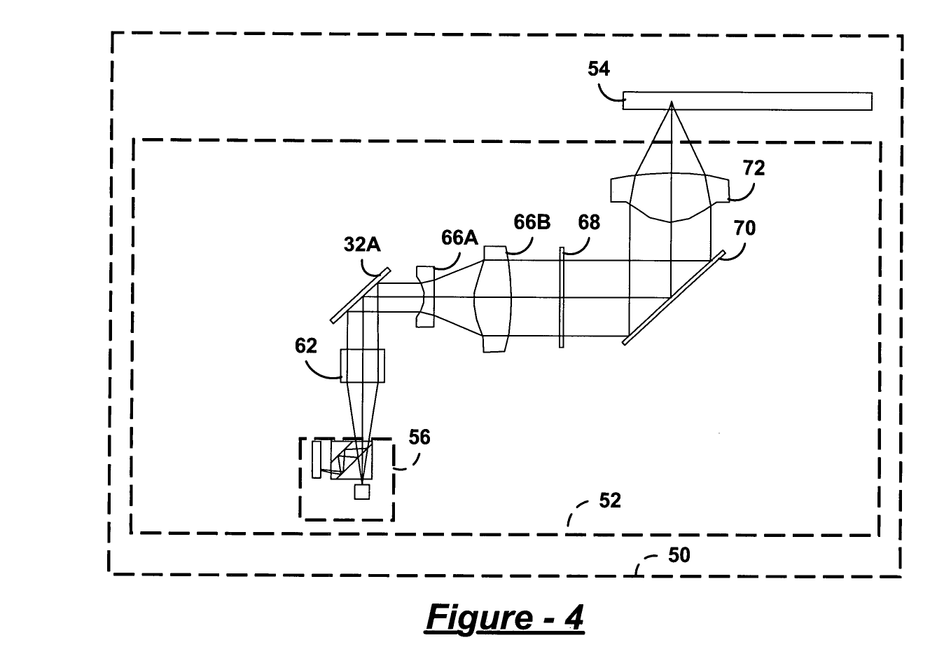

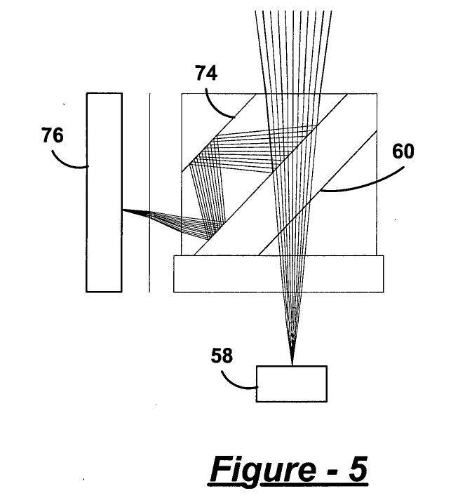

In a preferred embodiment, the present invention is used to fabricate masks that are used in manufacturing a grating inside an optical pickup unit in an optical disk drive (DVD and BD). Referring to FIG. 4, the optical drive 50 includes an optical pickup 52 oriented to illuminate and receive reflected laser light from an optical disk 54. An integrated grating unit 56 of the optical pickup 52 is illustrated in greater detail in FIG. 5. Turning to FIG. 5, laser diode 58 produces a polarized outgoing beam through polarization beam splitter 60. Returning to FIG. 4, the polarized outgoing beam is shaped by beam shaper 62, redirected by mirror 64, expanded by beam expander 66A and 66B, and transmitted through quarter wave plate 68. The outgoing beam is further redirected by mirror 70 through objective lens 72 to optical disk 54, where it is reflected back along the same beam path to the integrated grating unit 56 as an incoming beam. Returning to FIG. 5, the incoming beam reflects off a surface of polarization beam splitter 60 to a surface of a diffraction grating 74 produced according to the present invention. Grating 74 redirects the diffracted incoming beam back to the surface of polarization beam splitter 60, where the diffracted beam is redirected to photosensor 76. Additional details relating to the optical drive and pickup according to the present invention can be found in Integrated Optical Component and Optical Pick-Up Device to Fukakusa et al., U.S. Pat. No. 6,757,224, which is incorporated by reference herein in its entirety for any purpose.

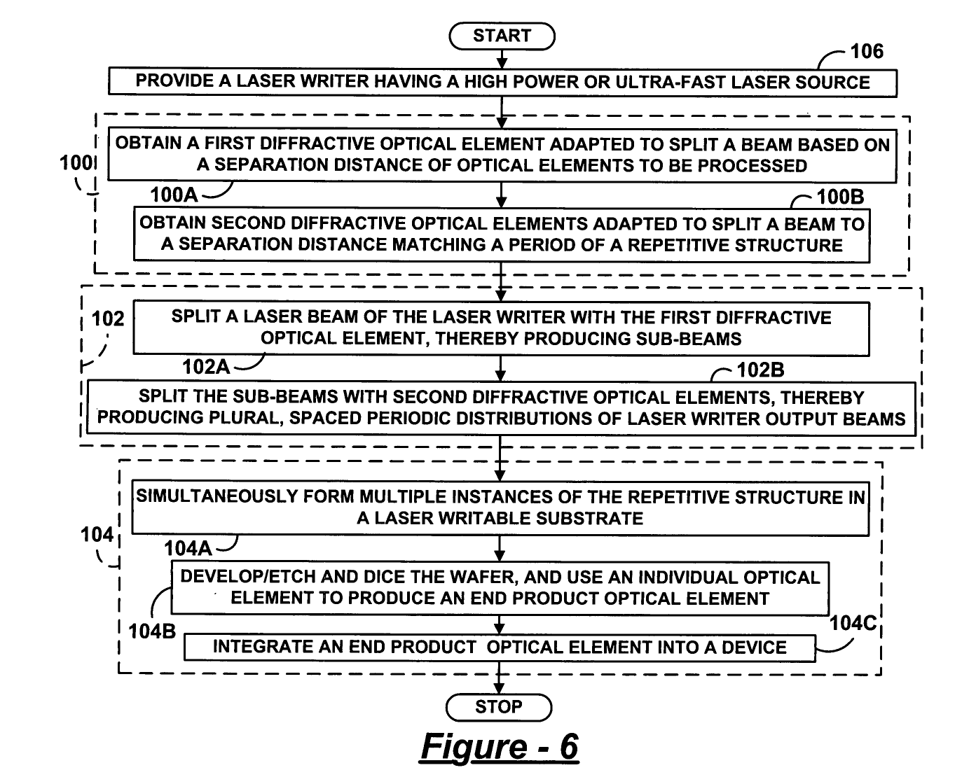

Turning now to FIG. 6, the method of making a highly repetitive micro-pattern using a laser writer includes three general steps. At step 100, one or more diffractive optical elements is obtained. At least one diffractive optical element obtained in step 100 is adapted to split a beam to a separation distance matching a period of a repetitive structure. Obtaining the DOE can include designing the DOE based on a period of a repetitive structure of a desired optical element. Additionally or alternatively, it can include manufacturing the DOE. Alternatively, it can include identifying and purchasing a suitable DOE, contracting for design and manufacture of a suitable DOE, and other approaches. In some embodiments, step 100 includes sub-steps 100A and 100B. At step 100A, at least one first diffractive optical element is obtained that is adapted to split a beam based on a separation distance of optical elements to be processed. At step 100B, a plurality of second diffractive optical elements are obtained that are adapted to split a beam to a separation distance matching a period of a repetitive structure.

At step 102, at least one beam of a laser writer is split with at least one of the diffractive optical elements. At least the diffractive optical element adapted to split the beam to the separation distance matching the period of the repetitive structure is used to split a beam in step 102. At least one periodic distribution of laser writer output beams is produced at least in part by splitting the beams at step 102. In some embodiments, step 102 includes sub-steps 102A and 102B. At sub-step 102A, a laser beam of the laser writer is split with the first diffractive optical element obtained in sub-step 100A. Sub-beams are produced by step 102A. At step 102B, the sub-beams produced at step 102A are split with second diffractive optical elements obtained at step 100B. Plural, spaced periodic distributions of laser writer output beams are produced at step 102B.

At step 104, a laser writable substrate is processed with the laser writer output beams. One or more instances of the highly repetitive micro-pattern are produced based on the repetitive structure at step 104. In some embodiments, step 104 includes sub-steps 104A-104C. At sub-step 104A, a surface of the laser writable substrate is exposed to multiple instances of a micro-pattern adapted to produce the repetitive structure in the laser writable substrate. At step 104B, the exposed substrate is developed or etched as appropriate to produce a wafer having multiple optical elements, each exhibiting the repetitive structure, and the wafer is diced to obtain individual elements, such as masks for producing diffraction gratings according to the present invention. The individual optical elements are further used to obtain end product optical elements, such as diffraction gratings at step 104B. At step 104C, one or more end product elements are integrated into a device, such as an optical pickup of an optical drive. Thus, some embodiments of the method of the present invention are methods of manufacture for an optical element, such as a mask or a diffraction grating, and/or a device, such as an optical pickup and/or an optical drive.

Some embodiments of the method of the according to the present invention can also include step 106. At step 106, a laser writer is provided that has sufficient laser power to support parallel operation according to the present invention. For example, step 106 can include providing a laser writer having a high power laser source and/or an ultra-fast laser source. In some embodiments, a laser source of relatively low power can be replaced with another laser source. Accordingly, some embodiments of the method according to the present invention can be a method of manufacturing a laser writer according to the present invention.

Due to the parallel processing nature of using the DOE, the consistency across the whole wafer is improved. Error and variation due to long term drift is eliminated. This method is particularly valuable for making a diffractive grating, including the DOE and the mold, since the device is highly repetitive. Since the beam pattern is very regular, the fabricated DOE can be designed with very high quality and with a minimal amount of effort in holding motion precision of scanners. Also, the multi-DOE arrangement provides more flexibility of the manufactured articles.

The beam size used in the laser writer is typically either 1 micron or 2 microns. However, it is envisioned that a beam size of 0.6 microns can be obtained with a stronger lens and/or shorter wavelength. Suitably designed DOEs may be purchased from vendors such as MEMS Optical. Typically, vendors design the DOEs according to the specification of the end product and the characteristics of the laser writer. However, designs for suitable DOEs can also be provided to vendors.

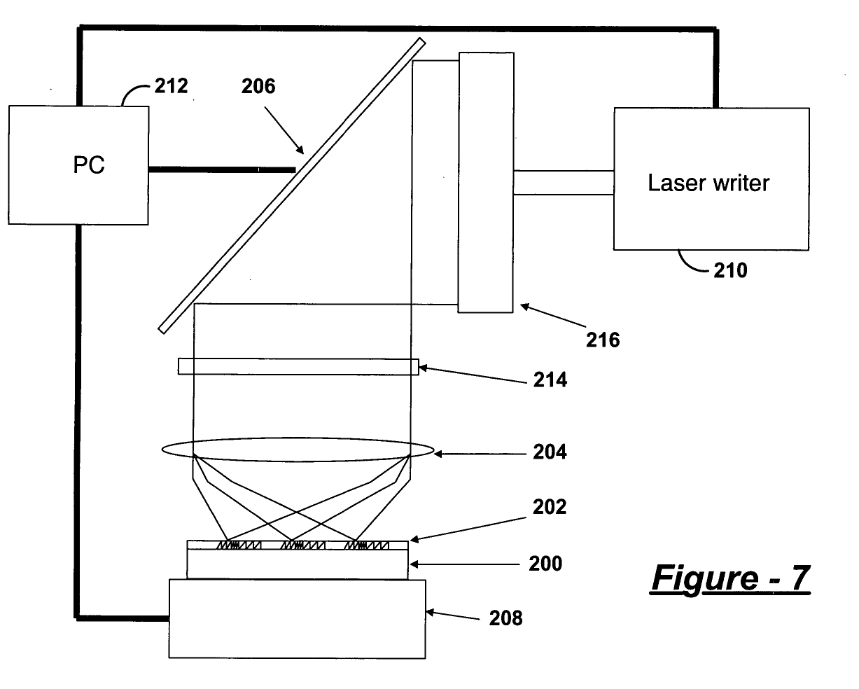

Various articles of manufacture in accordance with the present invention, including an optical pickup and an optical disk apparatus, are discussed with reference to FIGS. 7-9. Turning now to FIG. 7, a glass substrate such as BK7, soda lime, and fused silica, or any material that can be used as optical components, is prepared. Next, a suitable photo resist 202, such as PMMA (Polymethylmethacrylate) or SIPLEY SC-1827, S-1813, is spun on the substrate 200. Then, the photo resist 202 is placed after f-theta lens 204 in the present invention. Either or both of mirror 206 and stage 208 (mirror is preferable for fast fabrication) is moveable by processor 212 to raster scan or random scan the laser beam from a beam expander 216 of a laser writer 210. The stage 208 can be adapted to move in x, y, and z directions, and also to rotate in theta and/or phi directions. The mirror 206 can be attached to a PZT controlled motor or can be a resonant mirror. The DOE 214 splits the beam into the number of beams equal to a number of optical elements to be fabricated simultaneously, and each beam exposes each part on the photo resist 202 corresponding to each element.

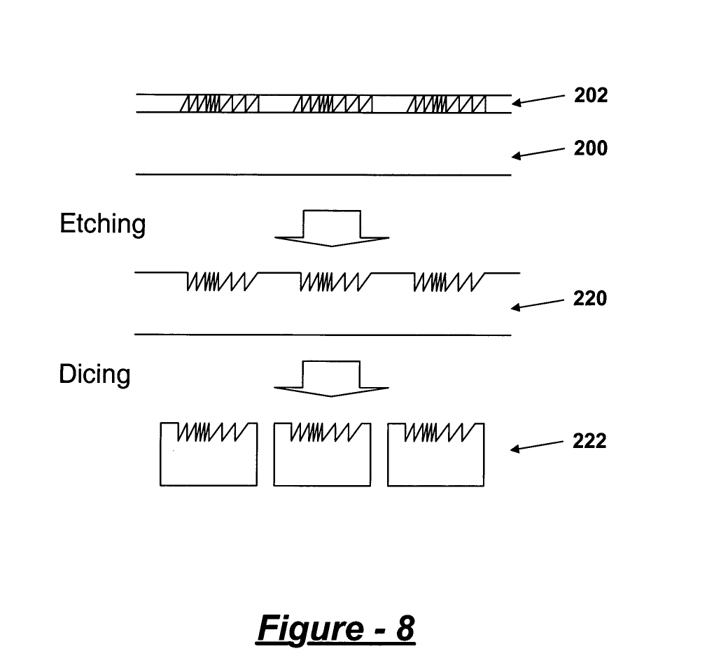

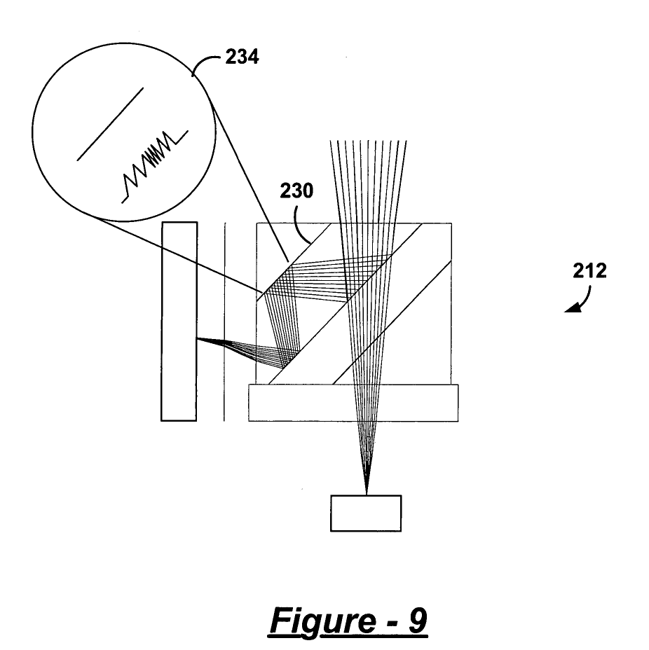

Turning now to FIG. 8, after exposure the substrate 200 with exposed photo resist 202 is developed and etched by any etching method to transfer the structure in the photo resist 202 to the substrate 200, such as: (a) dry etching using Reactive Ion Etching (RIE) or Ion Milling; and (b) wet etching using any etchant. Afterwards, the etched substrate is cleaned and diced into each element by use of a dicing saw to produce plural, identical optical elements 222. The elements 222 can have identical grey scale properties as a result of being simultaneously produced by one incidence of laser writer operation. Turning to FIG. 9, the elements, after being coated with a reflective material, can be assembled into grating units such as integrated grating unit 230 of an optical pickup 232 as illustrated at 234. This invention can be applied to refractive types of diffraction gratings in addition to reflective types. The present invention can also be used to produce discrete grating units in addition to integrated grating units. The optical pickup thus produced can be further integrated into in an optical disk apparatus, such as a DVD or BD player and/or recorder.

The present invention, decreases the cost of each integrated grating unit by a factor dependent on the number of sub-beams split from the main beam of the laser writer. The present invention also decreases the cost of each grating unit by a factor dependent on the increase of the yield due to parallel exposure in a short time period where there is no degradation nor fluctuation of the laser power of a laser writer.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus for making a highly repetitive micro-pattern using a laser writer, comprising:
one or more diffractive optical elements, wherein at least one diffractive optical element is adapted to split a beam of a laser writer into sub-beams based on a separation distance matching a period of a repetitive structure to be formed in a laser-writable substrate; and
one or more f-theta lenses, wherein at least one f-theta lens is disposed to intercept the sub-beams and form a periodic distribution of laser writer output beams.

2. The apparatus of claim 1, further comprising a laser writer having a high power laser source, wherein said diffractive optical element and said f-theta scan lens are disposed in an optical path of a laser beam of said laser writer.

3. The apparatus of claim 1, further comprising a laser writer having an ultra-fast laser source, wherein said diffractive optical element and said f-theta scan lens are disposed in an optical path of a laser beam of said laser writer.

4. The apparatus of claim 1, wherein said one or more diffractive optical elements includes a first diffractive optical element adapted to split a beam of a laser writer based on a separation distance of optical elements to be processed in the laser writable substrate, and said diffractive optical element adapted to split the beam of the laser writer into sub-beams based on the separation distance matching the period of the repetitive structure to be formed in the laser-writable substrate is one of a plurality of second diffractive optical elements manufactured to common specification.

5. The apparatus of claim 4, further comprising one or more collimating lenses disposed to intercept sub-beams produced by said first diffractive optical element.

6. The apparatus of claim 4, wherein said second diffractive optical elements are disposed to intercept sub-beams produced by said first diffractive optical element, thereby producing plural, spaced periodic distributions of laser writer output beams.

7. The apparatus of claim 6, further comprising an additional f-theta lens disposed between said first diffractive optical element and said second diffractive optical elements to intercept sub-beams produced by said first diffractive optical element.

8. The apparatus of claim 7, further comprising a plurality of collimating lenses disposed between said additional f-theta scan lens and said second diffractive optical elements to intercept sub-beams produced by said first diffractive optical element.

9. The apparatus of claim 1, further comprising a laser writable substrate disposed to intercept said laser writer output beams.

10. The apparatus of claim 1, further comprising a stage adapted to one or more of develop and etch a laser writable substrate impinged by said laser writer output beams, thereby producing a wafer having at least one instance of the repetitive structure formed therein.

11. A method of making a highly repetitive micro-pattern using a laser writer, comprising:
obtaining one or more diffractive optical elements, wherein at least one diffractive optical element is adapted to split a beam to a separation distance matching a period of a repetitive structure;
splitting at least one beam of a laser writer with at least one of the diffractive optical elements, at least including using the diffractive optical element adapted to split the beam to the separation distance matching the period of the repetitive structure, thereby producing at least one periodic distribution of laser writer output beams; and
processing a laser writable substrate with the laser writer output beams, thereby producing at least one instance of the highly repetitive micro-pattern based on the repetitive structure.

12. The method of claim 11, further comprising providing a laser writer having a high power laser source.

13. The method of claim 11, further comprising providing a laser writer having an ultra-fast laser source.

14. The method of claim 11, wherein obtaining one or more diffractive optical elements includes:
obtaining at least one first diffractive optical element adapted to split a beam based on a separation distance of optical elements to be processed; and
obtaining a plurality of second diffractive optical elements adapted to split a beam to a separation distance matching a period of a repetitive structure.

15. The method of claim 14, wherein splitting at least one beam of a laser writer includes:
splitting a laser beam of the laser writer with the first diffractive optical element, thereby producing sub-beams; and
splitting the sub-beams with second diffractive optical elements, thereby producing plural, spaced periodic distributions of laser writer output beams.

16. The method of claim 11, wherein processing a laser writable substrate with the laser writer output beams includes:
simultaneously exposing a surface of the laser writable substrate to multiple instances of a micro-pattern adapted to produce the repetitive structure in the laser writable substrate;
one or more of developing and etching the laser writable substrate, thereby producing a processed wafer of multiple, spaced optical elements; and
dicing the wafer, thereby obtaining individual optical elements.

17. The method of claim 16, further comprising:
using the individual optical elements to manufacture end product optical elements; and
integrating one or more of the end product optical elements into a device.

18. The method of claim 11, wherein obtaining a diffractive optical element includes designing the diffractive optical element.

19. The method of claim 11, wherein obtaining a diffractive optical element includes manufacturing the diffractive optical element.

20. The method of claim 11, further comprising subjecting one or more sub-beams produced by the diffractive optical element to one or more of an f-theta lens and a collimation lens, thereby producing the laser writer output beams.

21. An optical pickup, comprising:
a diffraction grating produced simultaneously with other, identical optical elements during exactly one incidence of operation of a laser writer using a diffractive optical element to split a beam of the writer into a number of sub-beams equal to or greater than a number of the optical elements simultaneously produced during the exactly one incidence of operation of the laser writer.

22. The optical pickup of claim 21, further comprising:
a polarization beam splitter; and
a laser diode producing a polarized outgoing beam through said polarization beam splitter.

23. The optical pickup of claim 22, further comprising a photosensor, wherein said diffraction grating, said polarization beam splitter, said laser diode, and said photosensor are disposed and oriented to ensure that an incoming laser beam returning along an optical path of said polarized outgoing beam reflects off a surface of said polarization beam splitter to said diffraction grating, and said diffraction grating redirects said incoming beam back to said surface of said polarization beam splitter at an angle ensuring redirection of said incoming beam to said photosensor.

24. An optical disk apparatus, comprising:
a diffraction grating produced simultaneously with other, identical optical elements during exactly one incidence of operation of a laser writer using a diffractive optical element to split a beam of the writer into a number of sub-beams equal to or greater than a number of the optical elements simultaneously produced during the exactly one incidence of operation of the laser writer; and
optics disposed and oriented to redirect an outgoing laser beam from said optical pickup to a predetermined position, said optics further disposed and oriented to return an incoming laser beam reflected from the predetermined position to said optical pickup along the beam path of the outgoing laser beam.

25. The optical disk apparatus of claim 24, further comprising:
a polarization beam splitter;
a laser diode producing the outgoing laser beam as a polarized outgoing beam through said polarization beam splitter; and
a photosensor, wherein said diffraction grating, said polarization beam splitter, said laser diode, and said photosensor are disposed and oriented to ensure that the incoming laser beam reflects off a surface of said polarization beam splitter to said diffraction grating, and said diffraction grating redirects said incoming beam back to said surface of said polarization beam splitter at an angle ensuring redirection of said incoming beam to said photosensor.
